(19) United States
(12) Patent Application Publication
(10) Pub. No.: US 2016/0304375 A1
(43) Pub. Date: Oct. 20, 2016

(54) PRODUCED WATER TREATMENT SYSTEM

(71) Applicant: HITACHI, LTD., Tokyo (JP)

(72) Inventors: Shigeki TERUI, Tokyo (JP); Hisashi ISOGAMI, Tokyo (JP); Yasuyuki YAGI, Tokyo (JP); Yasutaka KONDO, Tokyo (JP); Kazuya IWAMOTO, Tokyo (JP)

(73) Assignee: HITACHI, LTD., Tokyo (JP)

(21) Appl. No.: 15/092,111

(22) Filed: Apr. 6, 2016

(30) Foreign Application Priority Data
Apr. 14, 2015 (JP) 2015-082326

(51) Int. Cl. C02F 9/00; B03C 1/01; B03C 1/30; C02F 1/48; C02F 1/44; C02F 1/52; B01D 21/00; B03C 1/10; B01D 21/01; B01D 61/36

(52) U.S. Cl. CPC C02F 9/00; B01D 21/01; B03C 1/01; B03C 1/30; B01D 61/364; B01D 61/366; C02F 1/447; C02F 1/52; B01D 21/0009; B03C 1/10; C02F 1/488; B01D 2313/38; C02F 2103/10

(57) ABSTRACT

A produced water treatment system includes: a raw water flow passage to allow produced water to flow therethrough; a desalination flow passage connected to the raw water flow passage, and connected to a membrane distillation apparatus which removes a salt in the produced water flowing in from the raw water flow passage; and a bypass flow passage connected to the desalination flow passage and configured to supply the produced water to desalinated water obtained by desalination by the membrane distillation apparatus.

### BACKGROUND OF THE INVENTION

1. Field of the Invention

The present invention relates to a produced water treatment system.

2. Description of the Related Art

Water discharged from an oil field in association with oil production is called produced water. Such produced water is also discharged from a gas field. The produced water contains oil contents and inorganic solid components such as sand, and even further, large amounts of salts, organic matters, heavy metals, and the like depending on the site where drilling takes place. For this reason, the produced water is subjected to a required treatment and is then mostly dumped by underground re-injection or discharged to rivers or the sea. Alternatively, the produced water may be reused as irrigation water or boiler water.

A technique described in International Patent Application Publication No. WO2012/008013 (Patent Document 1) is known as a method of treating produced water. Patent Document 1 describes a technique which uses a combination of a desalination apparatus adopting a membrane method with a concentration apparatus adopting an evaporation method, and is designed to concentrate water containing salts, such as the produced water, stably and thus to separate the produced water into fresh water and the salts at a low equipment cost.

### SUMMARY OF THE INVENTION

While the amount of the produced water is increasing year after year, restrictions on the underground injection of the produced water and the discharge of the produced water to rivers or the sea are getting stricter from the ecological point of view. For this reason, there has been a growing demand for reuse of the produced water in recent years. In addition, an aging oil field is expected to undergo enhanced oil recovery in the future in order to curb reduction in production and to achieve an increase in production.

The enhanced oil recovery is performed with the purpose of recovering and increasing the production at the oil field suffering decline in production. This is a method of promoting movement of oil to a production well by injecting various fluids via injection wells provided around the production well, and thereby increasing the oil production from the production well. Methods of the enhanced oil recovery include: water flooding designed to inject water in order to increase a pressure in an oil stratum; thermal recovery designed to inject a heat source such as water vapor in order to reduce viscosity of and to enhance fluidity of the oil; chemical flooding designed to inject a surfactant or the like in order to change a surface tension of and to enhance fluidity of the oil; and the like.

Low-salinity water flooding designed to inject low-salinity water into injection wells has been drawing attention in recent years. The low-salinity water flooding is an enhanced oil recovery method designed to inject injection water having salinity in a range from about 0.1% by mass to 0.5% by mass via an injection well and to promote detachment of oil from rocks by use of actions of various ions contained in the injection water. Here, desalinated water prepared by desalinating seawater, which is abundant in nature, can be used as the injection water in the low-salinity water flooding. Accordingly, the low-salinity water flooding has an advantage that the enhanced oil recovery can be achieved at a lower cost than that of the chemical flooding that uses the heat and the additives.

Along with the demand for reuse of the produced water, there is a growing need for using (reusing) the produced water in the low-salinity water flooding as well. Since the produced water usually has the salinity in a range from 10% by mass to 20% by mass, it is preferable to subject the produced water to a desalination treatment in order to reuse the produced water. In general, a reverse osmosis membrane method is often employed in the desalination treatment of seawater having the salinity in a range from 3% by mass to 4% by mass. However, high-salinity water such as the produced water has a high osmotic pressure. Accordingly, in order to obtain freshwater from the produced water by the reverse osmosis membrane method, it is necessary to apply an extremely high pressure to the produced water and to use a membrane vessel having a sufficient strength to withstand the pressure. Therefore, the reverse osmosis membrane method is not practically applicable to the produced water. Given this situation, a possible option is to subject the produced water to a desalination treatment in accordance with one of evaporation methods using thermal energy. Among them, desalination techniques such as a multiple-effect evaporation method and a multiple-effect membrane distillation method are conceivable. These techniques are designed to obtain desalinated water by efficiently conducting evaporation with heat of heating water (water vapor at 100° C. or above or hot water at around 80° C.) and condensation with cooling water (cold water at around 20° C.)

In this regard, a flow rate and the salinity of the injection water used in the low-salinity water flooding vary depending on the well to which the injection water is injected or vary with time even in the case of the same well. For example, a suitable flow rate of the injection water depends on the pressure in the oil stratum which changes with time in the course of the production, and is therefore not constant. Meanwhile, the suitable salinity of the injection water also depends on types and concentrations of ions in formation water in the oil stratum to which the injection water is injected, and therefore varies depending on the well to which the injection water is injected. Moreover, the types and the concentrations of the ions in the formation water change as a consequence of the injection of the injection water into the stratum. Accordingly, although the appropriate salinity of the injection water is estimated to be in the range from 0.1% by mass to 0.5% by mass, the suitable salinity of the injection water is not always constant.

However, the salinity of the desalinated water, which is obtained by using the desalination apparatus employing the multiple-effect evaporation method or the multiple-effect membrane distillation method described above, usually falls below 0.1% by mass. For this reason, it is difficult to obtain the water having the intended salinity by controlling operating conditions of the apparatus. Moreover, a treatment flow rate of such a desalination apparatus is also constant, and it is difficult to change the treatment flow rate to an intended flow rate. Furthermore, since the desalination apparatus uses the heating water and/or the cooling water, the desalination apparatus has to rely on electric energy for heating or cooling the water unless there are a heating source and a cooling source around the desalination apparatus. Hence, the use of electric energy leads to an increase in cost.

The present invention has been made to solve the above problems and makes it an object thereof to provide a produced water treatment system, with which a salinity of water obtained by reusing produced water can be set flexibly at low cost.

As a result of earnest investigations for solving the problems, the inventors have reached a conclusion that the problems can be solved by providing a bypass flow passage, which is used for mixing produced water before being desalinated with desalinated water obtained by membrane distillation of the produced water.

According to the present invention, it is possible to provide a produced water treatment system, with which a salinity of water obtained by reusing produced water can be set flexibly at low cost.

### BRIEF DESCRIPTION OF THE DRAWINGS

FIG. 1 is a system diagram showing a produced water treatment system of a first embodiment;

FIG. 2 shows a flow to be carried out when the produced water treatment system of the first embodiment changes a flow rate of injection water;

FIG. 3 shows a flow to be carried out when the produced water treatment system of the first embodiment changes a salinity of the injection water;

FIG. 4 is a system diagram showing a produced water treatment system of a second embodiment;

FIG. 5 is a system diagram showing a produced water treatment system of a third embodiment; and

FIG. 6 is a system diagram showing a produced water treatment system of a fourth embodiment.

### DETAILED DESCRIPTION OF THE EMBODIMENTS

Modes for carrying out (embodiments of) the present invention will be described below with reference to the drawings as appropriate.

### 1. First Embodiment

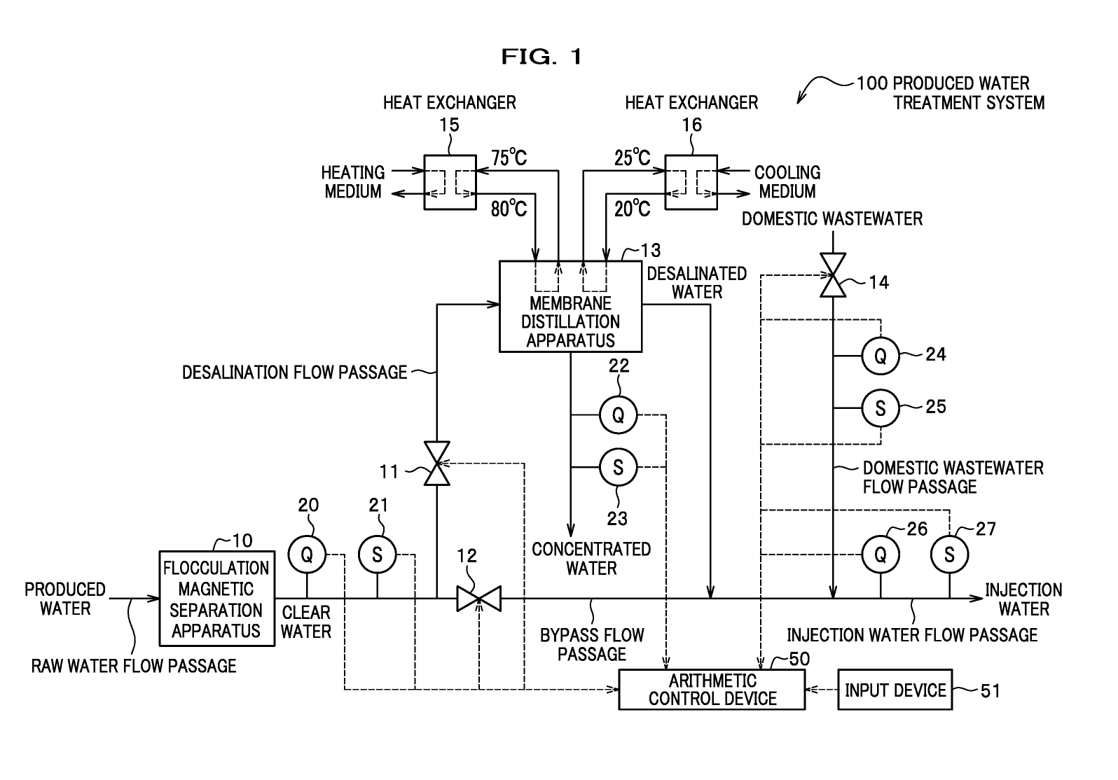

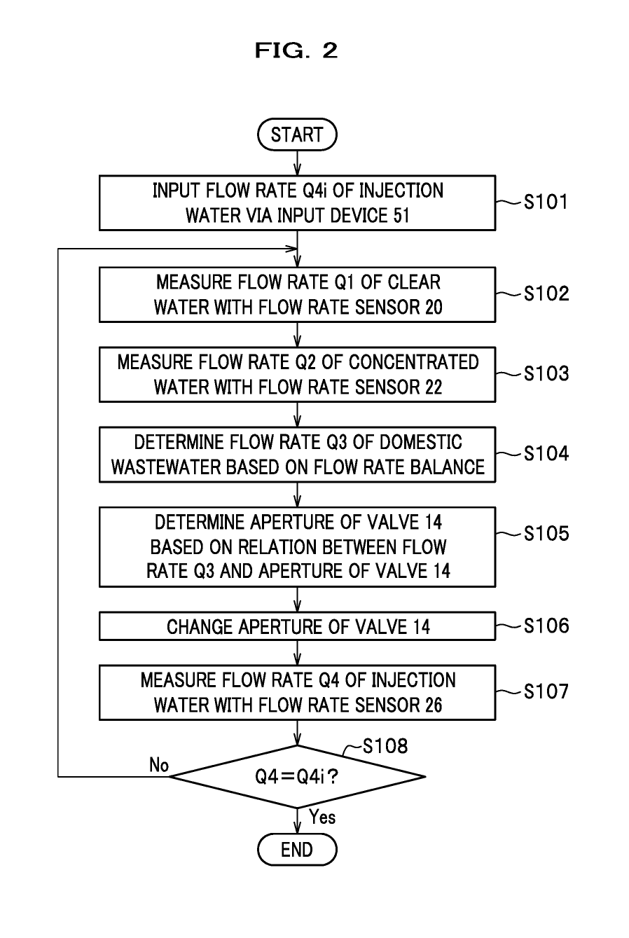

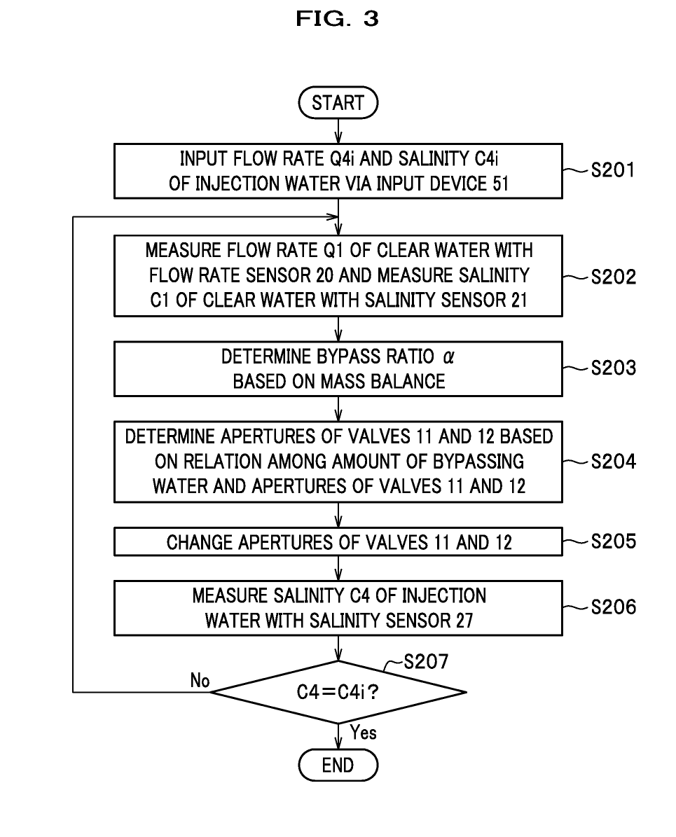

First, a system configuration of a produced water treatment system 100 will be described with reference to FIG. 1. Second, a system operation method of the produced water treatment system 100 will be described with reference to FIG. 2 and FIG. 3.

FIG. 1 is a system diagram showing the produced water treatment system 100 of a first embodiment. In this embodiment, the produced water treatment system 100 (hereinafter simply referred to as the “treatment system 100” as appropriate) is configured to reuse produced water, which is discharged at the time of oil production, as injection water by removing oil contents and solid contents from the produced water and then subjecting the produced water to a desalination treatment. Specifically, the produced water treatment system 100 obtains the injection water by diluting the produced water with desalinated water obtained by subjecting the produced water to a membrane distillation treatment. The injection water having an appropriate salinity can be obtained by diluting the high-salinity produced water with the desalinated water.

Meanwhile, the treatment system 100 is suitable for processing produced water discharged from an onshore oil field where it is difficult to use seawater desalination technologies and the like and is therefore hard to obtain fresh water (such as an oil field located in an inland desert area where seawater is not easily available). In this way, it is possible to prepare the injection water having the appropriate salinity even in an onshore region where the fresh water for the injection water is hardly available, and to inject the injection water into an oil field and the like located in the region.

The treatment system 100 includes a flocculation magnetic separation apparatus 10, a membrane distillation apparatus 13, heat exchangers 15 and 16, flow rate sensors 20, 22, 24, and 26, salinity sensors 21, 23, 25, and 27, valves 11, 12, and 14, an arithmetic control device 50, and an input device 51. In addition, the treatment system 100 is further provided with other components such as a pump (not shown) which serves as a drive source for circulating water (such as the produced water) in the treatment system 100.

Moreover, the treatment system 100 includes a raw water flow passage, a desalination flow passage, a bypass flow passage (a produced water supply flow passage), and an injection water flow passage. Among these flow passages, the raw water flow passage is provided for supplying the produced water to the flocculation magnetic separation apparatus 10. Meanwhile, the desalination flow passage is provided for supplying the produced water after being deprived of the oil contents and the solid contents by the flocculation magnetic separation apparatus 10 (i.e., clear water) to the membrane distillation apparatus 13. Moreover, the bypass flow passage is provided for allowing the flow of the clear water to be mixed with the clear water that is desalinated by the membrane distillation apparatus 13 (i.e., desalinated water). Furthermore, the injection water flow passage is provided for allowing the flow of the injection water obtained by mixing the desalinated water with the clear water.

Note that the produced water deprived of the oil contents and the solid contents by the flocculation magnetic separation apparatus 10 in the treatment system 100 is called the “clear water” for the sake of convenience. In other words, in this specification, the expression “clear water” is an expedient term to facilitate the understanding of the invention, and the clear water is the same as the produced water except that the oil contents and the solid contents are removed therefrom. In this context, the clear water is an example of the produced water. Accordingly, the expression “diluting the produced water with the desalinated water” also includes an aspect of “diluting the clear water with the desalinated water,” while the expression “desalinating the produced water by the membrane distillation apparatus” includes an aspect of “desalinating the clear water by the membrane distillation apparatus.”

The flocculation magnetic separation apparatus 10 is configured to remove the contained oil contents and the contained solid contents from the produced water to be treated by the treatment system 100. In the flocculation magnetic separation apparatus 10, although illustration is omitted, magnetic powder and a flocculant are added to the produced water. Thus, the oil contents and the solid contents in the produced water form floc, and cleaned water (the clear water) is obtained by removing the floc with a magnetic drum and the like. Meanwhile, in the treatment system 100, the oil contents and the solid contents are each reduced to a concentration below 10 mg/L, for example.

A flow rate of the clear water obtained by the flocculation magnetic separation apparatus 10 is measured with the flow rate sensor 20 provided downstream of the flocculation magnetic separation apparatus 10. In the meantime, a salinity of the clear water is measured with the salinity sensor 21 which is similarly provided on the downstream side. The term “salinity” here represents a concentration of anions (such as chloride ions and sulfate ions) constituting salts as well as metal ions (such as sodium ions and calcium ions) contained in the produced water.

Although details will be described later with reference to FIG. 2 and the like, a flow rate Q1 measured with the flow rate sensor 20 and a salinity C1 measured with the salinity sensor 21 are inputted to the arithmetic control device 50.

The membrane distillation apparatus 13 is configured to perform a desalination treatment on the clear water obtained by the flocculation magnetic separation apparatus 10 described above, and thereby to obtain the desalinated water that does not contain salts. Although illustration is omitted, the membrane distillation apparatus 13 includes: a heater for heating the clear water supplied through the desalination flow passage; a porous membrane to allow permeation of water vapor generated by heating the clear water; a decompression pump for decompressing a post-permeation side of the porous membrane; and a cooler configured to obtain the desalinated water by cooling the water vapor having permeated the porous membrane. Meanwhile, in the membrane distillation apparatus 13, salts (inclusive of some water) and the like having failed to permeate the above-described porous membrane are discharged as concentrated water to the outside of the membrane distillation apparatus 13.

Although details will be described later with reference to FIG. 2 and the like, a flow rate Q2 of the concentrated water is measured with the flow rate sensor 22 and is inputted to the arithmetic control device 50. Meanwhile, salinity C2 of the concentrated water is measured with the salinity sensor 23 and is inputted to the arithmetic control device 50 likewise.

The heater provided to the membrane distillation apparatus 13 is connected to the heat exchanger 15 through piping so as to allow a heating medium to flow therethrough. Meanwhile, the heating medium having the heat flows through the heat exchanger 15, and the clear water in the membrane distillation apparatus 13 is heated by the heat held by the heating medium. In this embodiment, the temperature of the heating medium to be supplied from the heat exchanger 15 to the heater of the membrane distillation apparatus 13 is around 80° C., and the temperature of the heating medium to be supplied from the heater of the membrane distillation apparatus 13 to the heat exchanger 15 is around 75° C.

In the meantime, the cooler provided to the membrane distillation apparatus 13 is connected to the heat exchanger 16 through piping so as to allow a cooling medium to flow therethrough. Meanwhile, the cooling medium having the cold flows through the heat exchanger 16, and the water vapor having permeated the above-described porous membrane is cooled by the cold held by the cooling medium. Then, the desalinated water is obtained by cooling the water vapor. In this embodiment, the temperature of the cooling medium to be supplied from the heat exchanger 16 to the cooler of the membrane distillation apparatus 13 is around 20° C., and the temperature of the cooling medium to be supplied from the cooler of the membrane distillation apparatus 13 to the heat exchanger 16 is around 25° C.

Now, a description will be given of the bypass flow passage for mixing the desalinated water obtained by the membrane distillation apparatus 13 with the clear water obtained by the above-described flocculation magnetic separation apparatus 10. As mentioned above, the bypass flow passage is configured to mix the clear water (which contains the salts) obtained by the flocculation magnetic separation apparatus 10 with the desalinated water (which does not contain the salts) obtained by the membrane distillation apparatus 13. The arithmetic control device 50 can change a flow rate of the clear water to flow through the bypass flow passage by controlling the valve 11 provided on the desalination flow passage and the valve 12 provided on the bypass flow passage. This control will be described later with reference to FIG. 2 and the like.

Domestic wastewater is supplied from a domestic wastewater flow passage to the mixed water of the desalinated water from the membrane distillation apparatus 13 and the clear water having flowed through the bypass flow passage. The domestic wastewater has a considerably lower salinity than the salinity of the produced water or the salinity of the clear water. A flow rate Q3 and a salinity C3 of the supplied domestic wastewater are measured with the flow rate sensor 24 and the salinity sensor 25, respectively. The flow rate Q3 and the salinity C3 thus measured are inputted to the arithmetic control device 50. Meanwhile, the arithmetic control device 50 can change an amount of supply of the domestic wastewater by controlling an aperture of the valve 14 provided on the domestic wastewater flow passage.

The mixed water of the desalinated water from the membrane distillation apparatus 13, the clear water having flowed through the bypass flow passage, and the domestic wastewater having flowed through the domestic wastewater flow passage flows through the injection water flow passage and is used as the injection water. The term injection water here represents injection water used for the water flooding or the low-salinity water flooding, for example. Meanwhile, a flow rate Q4 and a salinity C4 of the injection water flowing through the injection water flow passage are measured with the flow rate sensor 26 and the salinity sensor 27, respectively, and are inputted to the arithmetic control device 50.

The arithmetic control device 50 is configured to control apertures of the valves 11, 12, and 14 based on the flow rates Q1, Q2, Q3, and Q4 measured with the flow rate sensors 20, 22, 24, and 26 and on the salinities C1, C2, C3, and C4 measured with the salinity sensors 21, 23, 25, and 27. The input device 51 to be described later is connected to the arithmetic control device 50, and the arithmetic control device 50 is configured to control the apertures of the valves 11, 12, and 14 based on inputted values inputted to the input device 51. Here, a specific method of controlling the valves by the arithmetic control device 50 will be described later.

Although illustration is omitted, the arithmetic control device 50 includes a central processing unit (CPU), a random access memory (RAM), a read only memory (ROM), an interface (I/F), a hard disk drive (HDD), a sensor circuit, a control circuit, and the like. The arithmetic control device 50 is realized by causing the CPU to execute a given control program stored in the ROM.

The input device 51 is provided for allowing an administrator to input operating conditions such as the flow rate Q4 and the salinity C4 of the injection water. For example, the input device 51 includes a keyboard, a mouse, a monitor, and the like (none of which is illustrated). Here, values inputted via the keyboard and the like are inputted to the above-described arithmetic control device 50.

Next, the system operation method of the treatment system 100 explained with reference to FIG. 1 will be described with reference to FIG. 2 and FIG. 3 as appropriate.

When oil is produced in an oilfield, an amount of oil production is decreased due to reduction in pressure in an oil stratum induced by the oil production. Accordingly, stable oil production is secured by maintaining the pressure in the oil stratum by injecting the injection water into voids that are left over after the oil recovery. For this reason, it is preferable that the flow rate of the injection water be arbitrarily changeable. However, the amount of the produced water to be supplied to the treatment system 100 is variable. Moreover, the flow rate of the desalinated water obtained by the membrane distillation apparatus 13 is also variable. Accordingly, it is necessary to deal with complicated control based on various factors as described above in order to change the flow rate of the injection water or when the flow rate of the produced water or the desalinated water is changed.

Here, assuming that Q1 denotes the flow rate of the clear water measured with the flow rate sensor 20 shown in FIG. 1, Q2 denotes the flow rate of the concentrated water measured with the flow rate sensor 22 shown therein, Q3 denotes the flow rate of the domestic wastewater measured with the flow rate sensor 24 shown therein, and Q4 denotes the flow rate of the injection water measured with the flow rate sensor 26 shown therein, the following equation (1) holds true based on balance of the flow rates in the entire treatment system 100:

Q1+Q3=Q2+Q4

Q3=Q2+Q4−Q1 Equation (1).

Accordingly, the relation defined by the equation (1) is established among the flow rate Q1 of the clear water, the flow rate Q2 of the concentrated water, the flow rate Q3 of the domestic wastewater, and the flow rate Q4 of the injection water.

Here, when the flow rate Q3 of the domestic wastewater is calculated by using the equation (1), the flow rate of the desalinated water may potentially be used instead of the flow rate Q2 of the concentrated water. However, since the desalinated water from the membrane distillation apparatus 13 is purified water, the desalinated water has extremely low electric conductivity of equal to or below 10 μS/cm. For this reason, the flow rate of the desalinated water can hardly be measured by using an inexpensive electromagnetic flowmeter. On the other hand, the concentrated water from the membrane distillation apparatus 13 has sufficiently high electric conductivity. Accordingly, an inexpensive electromagnetic flowmeter can be suitably used for measuring the flow rate of the concentrated water.

Nonetheless, the use of the flow rate of the desalinated water does not have to be excluded and the flow rate Q3 of the domestic wastewater may be calculated by using the flow rate of the desalinated water as needed.

FIG. 2 shows a flow to be carried out when the produced water treatment system 100 of the first embodiment changes the flow rate Q4 of the injection water. The flow shown in FIG. 2 is executed by the above-described arithmetic control device 50 unless otherwise specified. Meanwhile, the apertures of the valves 11 and 12 are constant at the time of execution of the flow shown in FIG. 2. Here, the initial apertures of the valves 11 and 12 are set based on a result of calculation of a in accordance with equation (5) to be described later while using an initial flow rate and an initial salinity of the produced water, and an initial target flow rate and an initial target salinity.

First, the administrator inputs a desired flow rate Q4i of the injection water by operating the input device 51 (step S101). The inputted value Q4i is inputted to the arithmetic control device 50 (see FIG. 1). Then, the arithmetic control device 50 measures the flow rate Q1 of the clear water with the flow rate sensor 20 (step S102). Further, the arithmetic control device 50 measures the flow rate Q2 of the concentrated water with the flow rate sensor 22 (step S103).

Thereafter, the arithmetic control device 50 determines the flow rate Q3 of the domestic wastewater based on the flow rate Q1 and the flow rate Q2 thus measured, the inputted flow rate Q4i, and the above-mentioned equation (1) (i.e., the flow rate balance) (step S104). Subsequently, the arithmetic control device 50 determines the aperture of the valve 14 based on the flow rate Q3 of the domestic wastewater thus determined and a relational expression (which is predetermined based on a test run and the like) between the valve 14 and the flow rate Q3 of the domestic wastewater (step S105). Then, the arithmetic control device 50 changes the aperture of the valve 14 to the determined aperture (step S106).

After a lapse of several minutes to several tens of minutes, for example, from the point of change in the aperture of the valve 14, the arithmetic control device 50 measures the flow rate Q4 of the injection water with the flow rate sensor 26 (step S107). Subsequently, the arithmetic control device 50 compares the measured flow rate Q4 with the inputted value Q4i inputted in step S101, and determines whether or not these values are equal (step S108). When the values are equal (a direction indicated with Yes from step S108), the operation is continued without change. On the other hand, if the values are different (a direction indicated with No from step S108), the arithmetic control device 50 stands by for several minutes to several tens of minutes and then repeats the above-described step S102 to step S107 again.

According to the flow shown in FIG. 2, the flow rate Q4 of the injection water can be changed to a desired rate by controlling the flow rate Q3 of the domestic wastewater. Thus, the injection water can be stably injected at the desired flow rate Q4i depending on a location of the oilfield, the state of oil production thereof, conditions of the oil stratum, and the like.

Here, it is to be noted that the above-described flow shown in FIG. 2 does not take into account the salinity of the injection water. As described above, however, the suitable salinity of the injection water may vary depending on factors such as the region to inject the injection water. In the meantime, the salinity of the produced water may vary depending on the site and time of recovery thereof. In such a case, the salinity of the injection water to be injected may fluctuate if the injection water is injected under the same operating conditions. As a consequence, there may be a case where the salinity of the injection water should be controlled in order to maintain favorable oil production efficiency.

Here, assuming that C1 denotes the salinity of the clear water measured with the salinity sensor 21 shown in FIG. 1, C2 denotes the salinity of the concentrated water measured with the salinity sensor 23 shown therein, C3 denotes the salinity of the domestic wastewater measured with the salinity sensor 25 shown therein, and C4 denotes the salinity of the injection water measured with the salinity sensor 27 shown therein, the following equation (2) holds true based on the balance of the salinities in the entire treatment system 100:

Q1·C1+Q3·C3=Q2·C2+Q4·C4

Q3·C3=Q2·C2+Q4·C4−Q1·C1 Equation (2).

A ratio of the flow rate of the clear water flowing through the bypass flow passage relative to the flow rate Q1 of the clear water is defined as a (a bypass ratio). The bypass ratio α can be changed by controlling the valve 11 provided on the desalination flow passage and the valve 12 provided on the bypass flow passage. Moreover, the salts contained in the clear water having flowed through the desalination flow passage and supplied to the membrane distillation apparatus 13 are contained in the concentrated water discharged from the membrane distillation apparatus 13. Accordingly, the following equation (3) holds true:

Q1·(1−α)C1=Q2·C2 Equation (3).

The following equation (4) is derived from the equation (3) and the aforementioned equation (2):

Q3·C3=Q1·(1−α)C1+Q4·C4−Q1·C1 Equation (4).

In the meantime, the salinity C3 of the domestic wastewater is sufficiently smaller than the salinity C1 of the produced water. Accordingly, by using an approximation of C3/C1=0, the aforementioned equation (4) can be approximated to the following equation (5):

0=Q1·(1−α)+Q4·C4/C1−Q1

α=Q4·C4/Q1·C1 Equation (5).

As a consequence, the relation of the equation (5) is established among the ratio α (the bypass ratio) of the flow rate of the clear water flowing through the bypass flow passage, the flow rate Q1 and the salinity C1 of the clear water, and the flow rate Q4 and the salinity C4 of the injection water.

FIG. 3 shows a flow to be carried out when the produced water treatment system 100 of the first embodiment changes the salinity C4 of the injection water. The flow shown in FIG. 3 is executed by the above-described arithmetic control device 50 unless otherwise specified. First, the administrator inputs the desired flow rate Q4i of the injection water and a desired salinity C4i of the injection water via the input device 51 (step S201). The inputted values Q4i and C4i are inputted to the arithmetic control device 50 (see FIG. 1). Then, the arithmetic control device 50 measures the flow rate Q1 of the clear water with the flow rate sensor 20 and measures the salinity Cl of the clear water with the salinity sensor 21 (step S202).

Thereafter, the arithmetic control device 50 determines the ratio (the bypass ratio α) of the bypassing clear water through the bypass flow passage based on the flow rate Q1 and the salinity C1 thus measured, the flow rate Q4i and the salinity C4i thus inputted, and the above-mentioned equation (5) (i.e., mass balance) (step S203). Incidentally, the flow rate of the clear water to flow through the bypass flow passage is determined when the bypass ratio α is determined.

Subsequently, the arithmetic control device 50 determines the apertures of the valves 11 and 12 based on the bypass ratio α thus determined and a relational expression (which is predetermined based on a test run and the like) among the apertures of valves 11 and 12 and the amount of the bypassing water (step S204). Here, if the amount of the bypassing water is large, the aperture of the valve 11 is decreased while the aperture of the valve 12 is increased. On the other hand, if the amount of the bypassing water is small, the aperture of the valve 11 is increased while the aperture of the valve 12 is decreased. Then, the arithmetic control device 50 changes the apertures of the valves 11 and 12 to the determined apertures (step S205).

After a lapse of several minutes to several tens of minutes, for example, from the point of change in the apertures of the valves 11 and 12, the arithmetic control device 50 measures the salinity C4 of the injection water with the salinity sensor 27 (step S206). Subsequently, the arithmetic control device 50 compares the measured salinity C4 with the inputted value C4i inputted in step S201, and determines whether or not these values are equal (step S207). When the values are equal (a direction indicated with Yes from step S207), the operation is continued without change. On the other hand, if the values are different (a direction indicated with No from step S207), the arithmetic control device 50 stands by for several minutes to several tens of minutes and then repeats the above-described step S202 to step S207 again.

According to the flow shown in FIG. 3, the flow rate Q4 and the salinity C4 of the injection water can be controlled depending on the location of the oilfield, the state of oil production thereof, the conditions of the oil stratum, and the like. Thus, the injection water having the desired salinity C4i can be stably injected at the desired flow rate Q4i, and the stable oil production can be achieved accordingly.

### 2. Second Embodiment

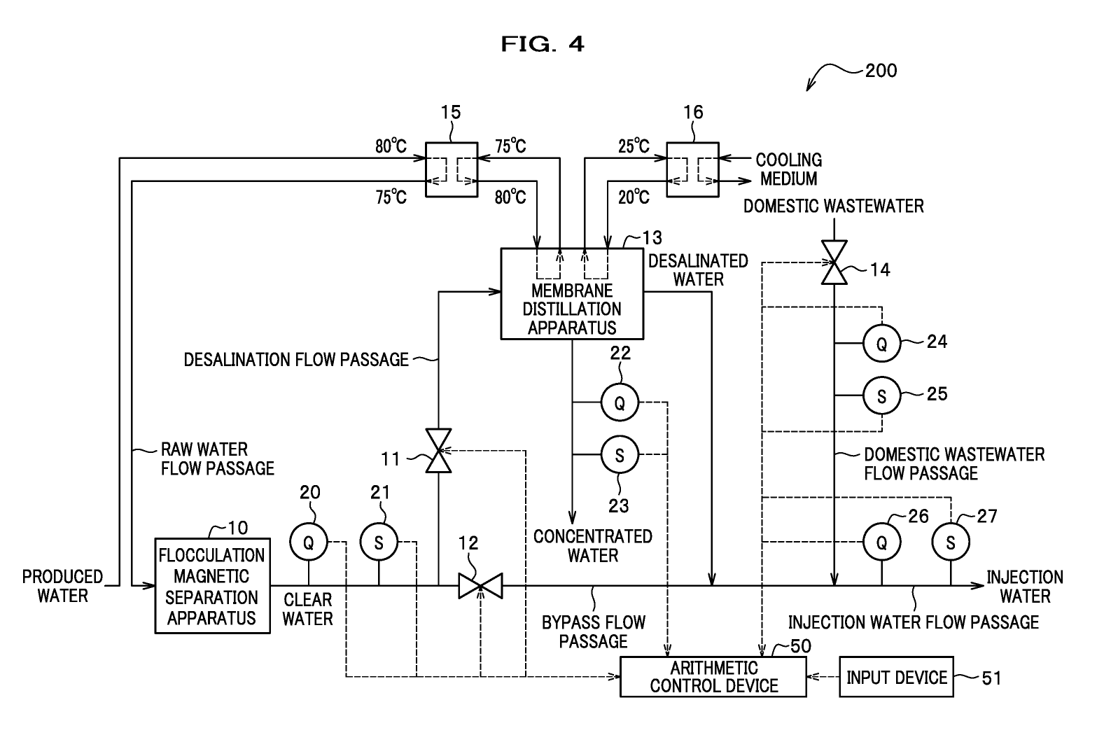

Next, a system configuration of a produced water treatment system 200 (hereinafter simply referred to as the “treatment system 200” as appropriate) according to a second embodiment will be described with reference to FIG. 4. Note that a system operation method applicable to the treatment system 200 shown in FIG. 4 is similar to the system operation method applicable to the treatment system 100 described above (see FIG. 2 and FIG. 3). Accordingly, the description of the system operation method performed in the treatment system 200 will be omitted. In addition, constituents in FIG. 4 which are the same as those in the system shown in FIG. 1 will be denoted by the same reference signs.

FIG. 4 is a system diagram showing the produced water treatment system 200 of the second embodiment. The oil recovered from several thousands of meters underground is heated by heat energy derived from the interior of the earth, and the produced water discharged together with the oil often has a high temperature (to be more precise, around 80° C., for example). Accordingly, in this case, the produced water is supplied to the heat exchanger 15 and the heat held by the produced water is used for heating the clear water in the membrane distillation apparatus 13. In this way, it is possible to substitute the produced water for the heat energy used in the membrane distillation apparatus 13, and thus to reduce supplemental energy consumption.

In addition, the produced water at the temperature of about 80° C., for example, is likely to bring about problems including: causing thermal degradations and resultant deteriorations in durability of resin components; causing irreversible demagnetization and a resultant deterioration in the separating performance of the magnet; and the like. Accordingly, it is difficult to supply the high-temperature produced water directly to the flocculation magnetic separation apparatus 10. On the other hand, the produced water with a temperature lowered by heat dissipation in the heat exchanger 15 can moderate these problems and hence be supplied directly to the flocculation magnetic separation apparatus 10.

### 3. Third Embodiment

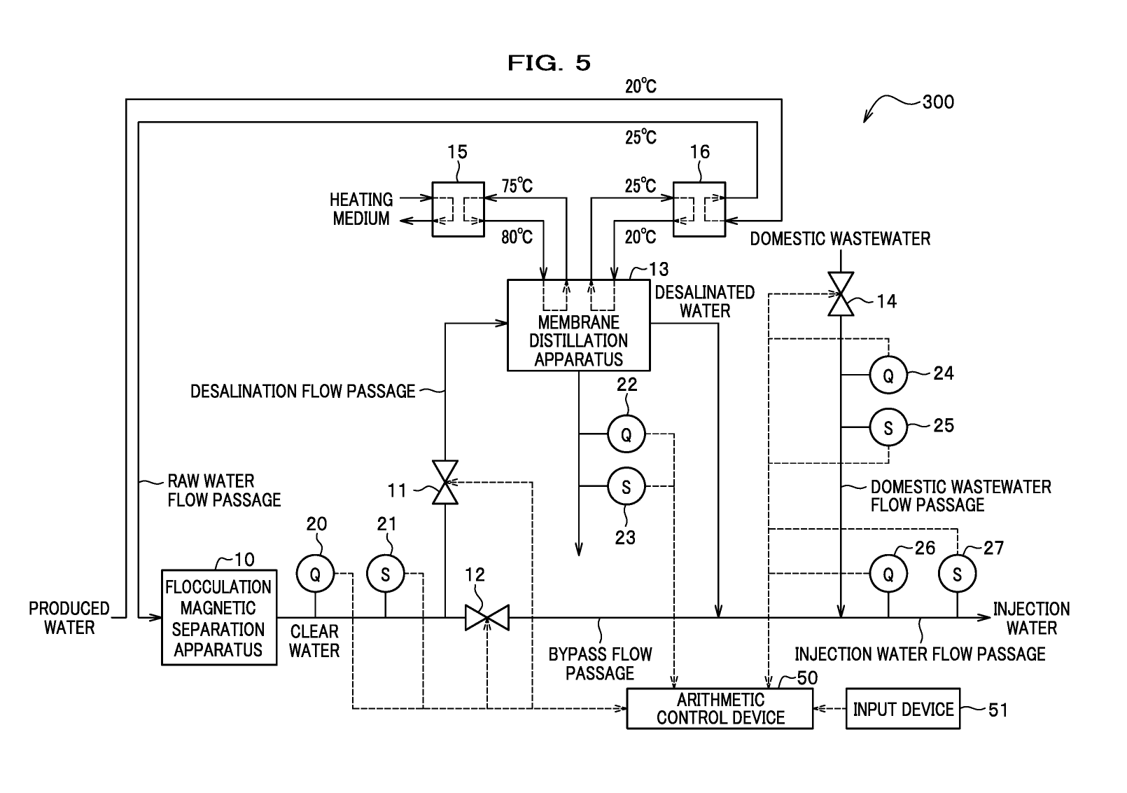

Next, a system configuration of a produced water treatment system 300 (hereinafter simply referred to as the “treatment system 300” as appropriate) according to a third embodiment will be described with reference to FIG. 5. Note that a system operation method applicable to the treatment system 300 shown in FIG. 5 is similar to the system operation method applicable to the treatment system 100 described above (see FIG. 2 and FIG. 3). Accordingly, the description of the system operation method performed in the treatment system 300 will be omitted. In addition, constituents in FIG. 5 which are the same as those in the system shown in FIG. 1 will be denoted by the same reference signs.

FIG. 5 is a system diagram showing the produced water treatment system 300 of the third embodiment. As mentioned previously, the produced water immediately after its production often has a high temperature. Nonetheless, the produced water falls in temperature when the produced water is transported for a long distance through a pipeline provided on the ground or in the sea (for example, the temperature may fall to 20° C. or below in a cold area). Accordingly, in this case, the produced water is supplied to the heat exchanger 16 and the cold held by the produced water is used for cooling the water vapor in the membrane distillation apparatus 13. In this way, it is possible to substitute the produced water for the cold energy used in the membrane distillation apparatus 13, and thus to reduce supplemental energy consumption.

In the meantime, while seawater is often used as a cold source for the membrane distillation apparatus 13, the produced water is used as an effective cold source in an onshore oil field installed in a cold area where the seawater is not easily available, for example. In addition, waste heat from the membrane distillation apparatus 13 is recycled for heating the produced water. Accordingly, there is another advantage that thermal efficiency of the system is improved.

### 4. Fourth Embodiment

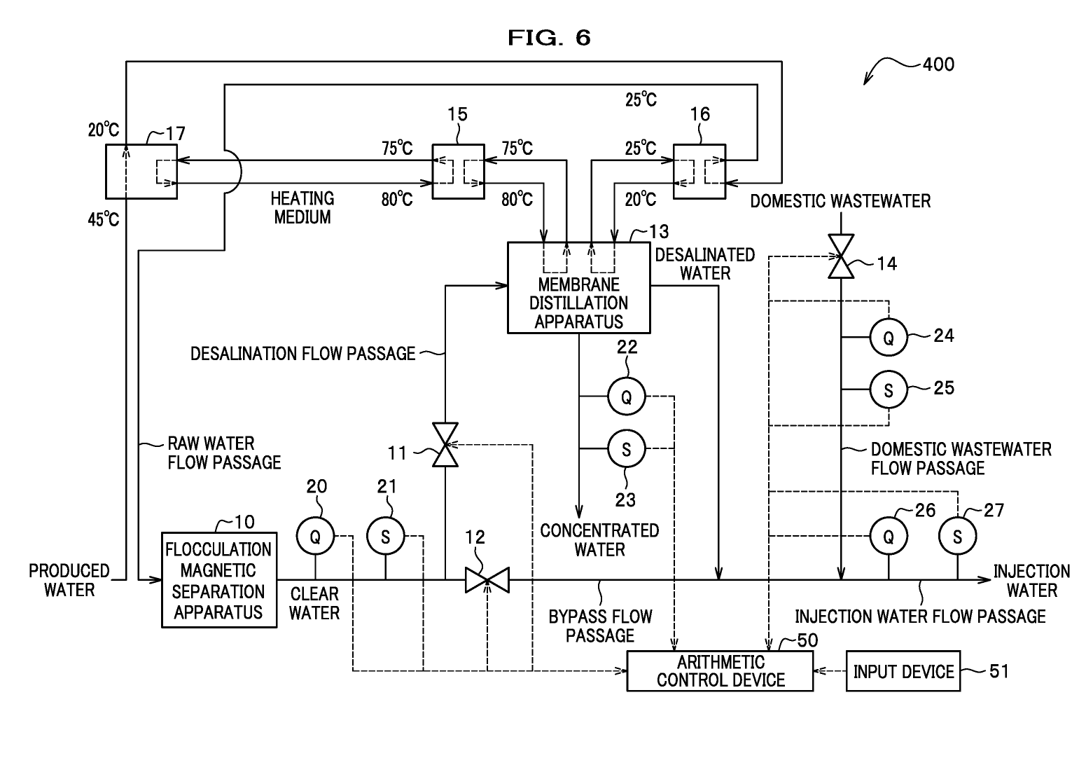

Next, a system configuration of a produced water treatment system 400 (hereinafter simply referred to as the “treatment system 400” as appropriate) according to a fourth embodiment will be described with reference to FIG. 6. Note that a system operation method applicable to the treatment system 400 shown in FIG. 6 is similar to the system operation method applicable to the treatment system 100 described above (see FIG. 2 and FIG. 3). Accordingly, the description of the system operation method performed in the treatment system 400 will be omitted. In addition, constituents in FIG. 6 which are the same as those in the system shown in FIG. 1 will be denoted by the same reference signs.

FIG. 6 is a system diagram showing the produced water treatment system 400 of the fourth embodiment. The temperature of the produced water supplied to the above-described treatment system 200 is about 80° C., for example, while the temperature of the produced water supplied to the treatment system 300 is about 20° C., for example. In the meantime, the treatment system 400 shown in FIG. 6 is suitable when the produced water has an intermediate temperature between the aforementioned temperatures (such as about 45° C.).

The treatment system 400 shown in FIG. 6 includes a heat pump 17, which is configured to heat the heating medium employed in the membrane distillation apparatus 13 by using the heat held by the produced water. The heat pump 17 is a device which transfers heat by means of electric energy. By using the heat pump 17, the produced water not suitable for the heat source or the cold source can be efficiently used as the heat source. Thereafter, the produced water which is cooled as a consequence of heat dissipation in the heat pump 17 is supplied to the heat exchanger 16, and the cold held by the produced water is used for cooling the water vapor in the membrane distillation apparatus 13. In this way, it is possible to further reduce supplemental energy consumption by the membrane distillation apparatus 13.

### 5. Modified Examples

Although the present invention has been described above with reference to the four embodiments, it is to be understood that the present invention is not limited only to these embodiments.

For example, the apparatus for removing the oil contents and the solid contents from the produced water is not limited only to the above-described flocculation magnetic separation apparatus 10, but may be any of a hydrocyclone, a coalescer, a dissolved air flotation system, a media filter, a membrane separation device, and the like.

Moreover, in the above-described embodiments, the whole quantity of the raw water is supplied to the flocculation magnetic separation apparatus 10 and the oil contents and the solid contents in the raw water are removed. However, it is also possible to install the flocculation magnetic separation apparatus 10 on the desalination flow passage so as to remove the oil contents and the solid contents only from the produced water that flows into the membrane distillation apparatus 13. In this case, the amount of the produced water to be supplied to the flocculation magnetic separation apparatus 10 can be reduced by an amount of the produced water to flow in the bypass flow passage. Thus, it is possible to downsize the flocculation magnetic separation apparatus 10. In particular, the injection water may be allowed to contain the oil contents and the solid contents depending on the oil stratum into which the injection water is injected. For this reason, although the produced water that flows in the bypass flow passage contains the oil contents and the solid contents, this configuration is suitable when the injection water is injected into the oil stratum that accepts those components.

Meanwhile, regarding the system diagram of each of the above-described embodiments, another possible option is to provide a media filter or a membrane separation device (neither of which is shown) on the downstream of the flocculation magnetic separation apparatus 10 for the purpose of further removing the oil contents and the solid contents. In this case, the oil contents in the clear water after being processed by any of these devices can be reduced to a concentration below 1 mg/L and the solid contents therein can be reduced to a concentration below 1 mg/L. Thus, it is possible to improve membrane distillation efficiency of the membrane distillation apparatus 13 located downstream and thus to obtain a larger amount of the desalinated water.

In the meantime, the heat held by the heating medium supplied to the heat exchanger 15 is used for heating the clear water in the membrane distillation apparatus 13. Instead, this heating process may be carried out, for example, by using: energy from electricity or gas; waste heat discharged from a compressor, a generator, a motor, and the like used in an oil production site; waste heat discharged from a power plant; waste heat from a general factory; electric energy obtained by biomass power generation or photovoltaic power generation; hot water obtained from a solar heat panel; hot spring water; and the like.

Furthermore, the cold held by the cooling medium supplied to the heat exchanger 16 is used for cooling the water vapor in the membrane distillation apparatus 13. Instead, this cooling process may be carried out, for example, by using: energy from electricity or gas; and the cold held by the domestic wastewater, factory wastewater, river water, treated sewage, deep seawater, groundwater, drinking water, and the like.

Meanwhile, the temperatures indicated in FIG. 1 and FIG. 4 to FIG. 6 are mere examples. The heat exchangers 15 and 16 and the heat pump 17 can be appropriately selected in order to achieve suitable temperatures depending on the application.

In addition, the above-described embodiments explain the examples of repeating step S102 to step S107 shown in FIG. 2 or step S202 to step S207 shown in FIG. 3 “after the lapse of several minutes to several tens of minutes .” However, depending on the oil production stability, the repetition of the steps may take place “after a lapse of several days to several weeks” instead of the period shown as the example in the embodiments. In other words, the interval for the repetition may be set at a desired period depending on an operational state of the produced water treatment system 100.

Meanwhile, in the above-described embodiments, the flows shown in FIG. 2 and FIG. 3 are automatically executed by the arithmetic control device 50. However, if the required amount of the injection water or the salinity thereof does not significantly change, then the administrator of the system may manually operate the valves and adjust the amount and the salinity of the injection water in place of the arithmetic control device 50 as appropriate. Moreover, the amount and the salinity of the injection water may be adjusted while switching between the automatic execution by the arithmetic control device 50 and the manual operation.

Furthermore, the water to be added to the mixed water of the desalinated water and the clear water is not limited only to the domestic wastewater, and any kind of water such as groundwater, factory wastewater, industrial water, river water, and treated sewage is applicable as long as such water has a lower salinity than the salinity of the produced water (which is a concept including the clear water).

In the meantime, although the produced water from the oil field is used as the example in the above-described embodiments, the treatment system of each of the embodiments is also applicable to produced water generated from a gas field, for example. Moreover, each of the systems of the present invention can be employed for treating and reusing concentrated seawater (brine) generated in the course of seawater desalination by the reverse osmosis membrane method, or concentrated salt water having a high salinity to be discharged from any other desalination system. Furthermore, each of the systems can also be employed for desalination treatments of wastewater in the petrochemical industry, which involves the desalination and reuse of the salt water discharged from oil desalination systems.

In addition, while the produced water is reused as the injection water in the above-described examples, the produced water can also be used as industrial water, irrigation water, boiler water, and the like by appropriately adjusting the salinity thereof. Even further, the produced water can also be used as drinking water by purging the produced water of substances that are harmful to human body, such as organic matters and heavy metals.

### DESCRIPTION OF REFERENCE SIGNS

10: Flocculation magnetic separation apparatus (separation apparatus); 11: valve (first flow rate adjustment device); 12: valve (second flow rate adjustment device); 14: valve (conditioning water flow rate adjustment device); 13: membrane distillation apparatus; 15, 16: heat exchanger; 17: heat pump; 50: arithmetic control device; 20, 22, 24, 26: flow rate sensor; 21, 23, 25, 27: salinity sensor; and 100, 200, 300, 400: treatment system.

1. A produced water treatment system comprising:
a raw water flow passage to allow produced water to flow therethrough;
a desalination flow passage connected to the raw water flow passage, and connected to a membrane distillation apparatus configured to remove a salt in the produced water flowing in from the raw water flow passage; and
a produced water supply flow passage connected to the desalination flow passage and configured to supply the produced water to desalinated water obtained from desalination by the membrane distillation apparatus.

2. The produced water treatment system according to claim 1, further comprising:
an injection water flow passage to allow water, which is obtained by supplying the produced water flowing through the produced water supply flow passage to the desalinated water obtained from the desalination by the membrane distillation apparatus, to flow therethrough, wherein
the water flowing through the injection water flow passage is used as injection water.

3. The produced water treatment system according to claim 1, further comprising:
a separation apparatus provided on the raw water flow passage and configured to remove an oil content and a solid content contained in the produced water flowing through the raw water flow passage;
a conditioning water flow passage connected to a downstream side of the produced water supply flow passage and configured to supply conditioning water to mixed water of the desalinated water having flowed through the desalination flow passage and the produced water having flowed through the produced water supply flow passage;
a conditioning water flow rate adjustment device provided on the conditioning water flow passage and configured to adjust a flow rate of the conditioning water supplied to the mixed water; and
an arithmetic control device configured to control the conditioning water flow rate adjustment device based on a flow rate of the produced water deprived of the oil content and the solid content by the separation apparatus, and on a flow rate of concentrated water discharged from the membrane distillation apparatus.

4. The produced water treatment system according to claim 3, further comprising:
a first flow rate adjustment device configured to adjust a flow rate of the produced water to be supplied to the membrane distillation apparatus;
a second flow rate adjustment device configured to adjust a flow rate of the produced water to flow through the produced water supply flow passage; and
the arithmetic control device configured to control the first flow rate adjustment device and the second flow rate adjustment device based on the flow rate and a salinity of the produced water deprived of the oil content and the solid content by the separation apparatus.

5. The produced water treatment system according to claim 1, wherein
the membrane distillation apparatus comprises:
a heating device configured to heat the supplied produced water; and
a cooling device configured to cool water vapor generated by membrane permeation and to form the desalinated water, and
at least one of the heating device and the cooling device is driven by use of any of heat and cold held by the produced water flowing through the raw water flow passage.
